(19) United States
(12) Patent Application Publication
(10) Pub. No.: US 2023/0029280 A1
(43) Pub. Date: Jan. 26, 2023

(54) SYSTEM AND METHOD FOR PROVIDING A WARRANTY ASSIGNED TO A LOGICAL DEVICE GROUP

(71) Applicant: Dell Products, L.P., Round Rock, TX (US)

(72) Inventors: Vaideeswaran Ganesan, Bangalore (IN); Praveen Lalgoudar, Bangalore (IN); Winston X. Fernandes, Sirsi (IN); Abhishek Gupta, Rohini (IN); Pandiyan Varadharajan, Bangalore (IN); Rekha MS, Karnataka (IN)

(73) Assignee: Dell Products, L.P., Round Rock, TX (US)

(21) Appl. No.: 17/409,904

(22) Filed: Aug. 24, 2021

(30) Foreign Application Priority Data
Jul. 23, 2021 (IN) 202111033234

(51) Int. Cl. G06Q 30/00; H04L 12/24; G06F 16/23

(52) U.S. Cl. CPC G06Q 30/012; H04L 41/5009; G06F 16/23

(57) ABSTRACT

Systems and methods provide a logical-physical warranty that is applied to nodes at a logical grouping level, such as a cluster. A logical warranty is associated with the nodes in the logical group or cluster in addition to each node's original individual warranty. The logical warranty stretches the expiration dates for individual warranties to a worst-case date inside the logical group. Customers build, teardown and extend the clusters, and the logical warranty is assigned to nodes in the cluster. The logical warranty is associated with a cluster of a defined size, such as a number of nodes expected, which can be expanded in the future as needed. The logical warranty ensures that there is uniform Service Level Agreement (SLA) for the nodes in the cluster during the warranty lifetime thereby simplifying the support for the cluster.

### CROSS REFERENCE TO RELATED APPLICATIONS

This patent application claims priority to co-pending, commonly assigned Indian Patent Application No. 202111033234, filed Jul. 23, 2021 and entitled “System and Method for Providing a Warranty Assigned to a Logical Device Group,” the entire contents of which are incorporated by reference herein.

### FIELD

The present disclosure generally relates to warranties for data centers and, more particularly, to a logical-physical warranty concept that can be applied to a logical grouping level, such as a cluster.

### BACKGROUND

Information Handling Systems (IHSs) process, compile, store, and/or communicate information or data for business, personal, or other. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Groups of IHSs may be housed within data center environments. A data center may include a large number of IHSs, such as enterprise blade servers that are stacked and installed within racks. A data center may include large numbers of such server racks that are organized into rows of racks. Administration of such large groups of IHSs may require teams of remote and local administrators working in shifts in order to support around-the-clock availability of the data center operations while minimizing any downtime. A data center may include a wide variety of hardware systems and software applications that may each be separately covered by warranties. The warranties available for a particular data center are typically based upon the tier of the city where the data center is located, the type of devices in the data center, and customer preferences. An IT operation center may manage IHSs residing in multiple geographic locations. The applicable warranty for those IHs depends on where the server is located. Accordingly, an IT operation center may have to deal with different warranties across different data centers.

### SUMMARY

Systems and methods provide a logical-physical warranty that is applied to nodes at a logical grouping level, such as a cluster. A logical warranty is associated with the nodes in the logical group or cluster in addition to each node's original individual warranty. The logical warranty stretches the expiration dates for individual warranties to a worst-case date inside the logical group. Customers build, teardown and extend the clusters, and the logical warranty is assigned to nodes in the cluster. The logical warranty is associated with a cluster of a defined size, such as a number of nodes expected, which can be expanded in the future as needed. The logical warranty ensures that there is uniform Service Level Agreement (SLA) for the nodes in the cluster during the warranty lifetime thereby simplifying the support for the cluster.

### BRIEF DESCRIPTION OF THE DRAWINGS

The present invention(s) is/are illustrated by way of example and is/are not limited by the accompanying figures. Elements in the figures are illustrated for simplicity and clarity and have not necessarily been drawn to scale.

FIG. 1 is a block diagram illustrating a plurality of data centers that are managed by a central operations center according to an example embodiment.

FIG. 2 illustrates the architecture for a logical group or cluster of IHSs or other nodes.

FIG. 3 is a flowchart illustrating a process for adding a head node to a cluster warranty.

FIG. 4 is a flowchart illustrating a process for adding a new node to a cluster warranty.

FIG. 5 is a flowchart illustrating a process for removing a node from a cluster.

FIGS. 6A and 6B illustrate a set of warranties associated with three independent nodes before and after they are combined in a cluster and assigned to the same cluster warranty.

### DETAILED DESCRIPTION

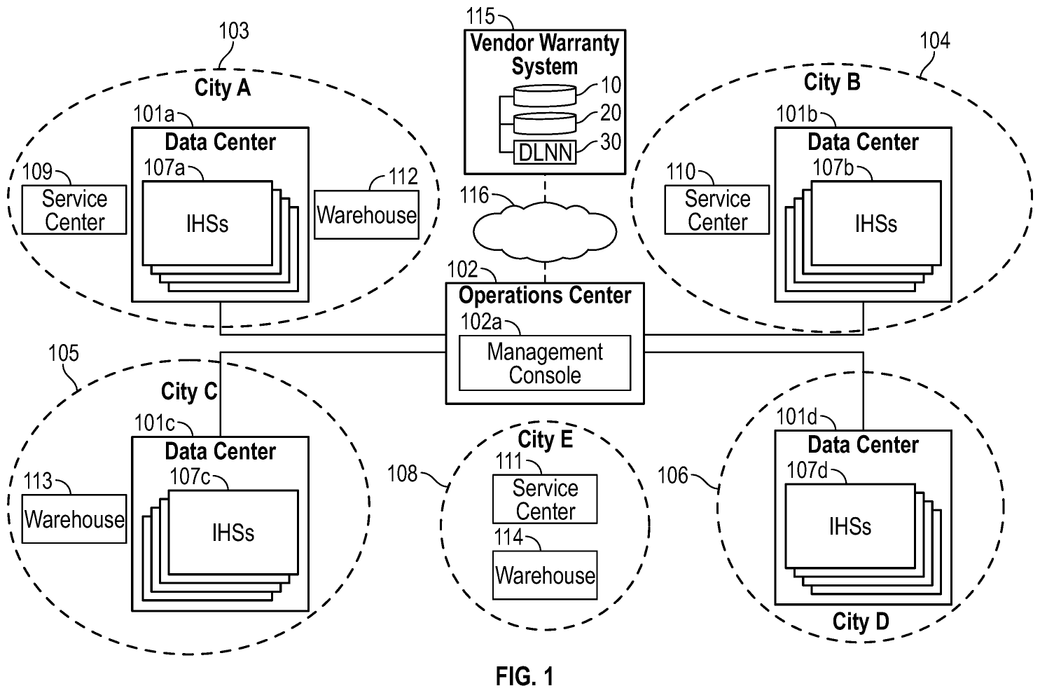

FIG. 1 is a block diagram illustrating a plurality of data centers 101a-d that are managed by a central operations center 102. Each data center 101a-d is located in a different city 103-106. Data centers 101a-d may include a large number of IHSs 107a-d that may be installed as components of a chassis. Multiple chassis may be housed within a rack, and data centers 101a-d may utilize large numbers of racks, with various different types of chassis installed in the various rack configurations. By configuring a chassis with different IHS 107a-d, the chassis may be adapted to support specific types of operations, thus providing a computing solution that is directed toward a specific type of computational task. Components of the IHSs 107a-d may be provided by multiple vendors and may be installed at different times. Accordingly, data center administrators at operations center 102 need to track and assess the warranty coverage of the components within the various data centers 101a-d. Certain components of operations center 102 and/or data centers 101a-d may be configured to implement the systems and methods described herein.

IHSs 107a-d may comprise a remote access controller, baseboard management controller, or chassis management controller that allows information technology (IT) administrators at a remote operations center 102 to deploy, update, monitor, and maintain IHSs 107a-d remotely. As a non-limiting example of a remote access controller, the integrated Dell Remote Access Controller (iDRAC) from Dell® is embedded within Dell PowerEdge™ servers and provides such remote functionality.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS 107a-d may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS 107a-d may include Random Access Memory (RAM), one or more processing resources such as a Central Processing Unit (CPU) or hardware or software control logic, Read-Only Memory (ROM), and/or other types of nonvolatile memory. Additional components of an IHS 107a-d may include one or more disk drives, one or more network ports for communicating with external devices as well as various I/O devices, such as a keyboard, a mouse, touchscreen, and/or a video display. An IHS 107a-d may also include one or more buses operable to transmit communications between the various hardware components.

IHSs 107a-d may be used to support a variety of e-commerce, multimedia, business, and scientific computing applications. In some cases, these applications may be provided as services via a cloud implementation. IHSs 107a-d are typically configured with hardware and software that provide leading-edge computational capabilities. IHSs 107a-d may also support various numbers and types of storage devices. Accordingly, services provided using such computing capabilities are typically provided as high-availability systems that operate with minimum downtime. The warranties provided by vendors of IHSs 107a-d and the related hardware and software allow the data centers 101a-d to provide contracted Service Level Agreement (SLA) to customers. Upon failure of an IHS 107a-d, data centers 101a-d and operations center 102 typically relies on a vendor to provide warranty support in order to maintain contracted SLAs.

Existing warranty systems usually comprise a standard warranty for a particular device, such as an IHS, server, etc. That standard warranty comprises the typical service coverage that is offered to customers by a vendor, such as a manufacturer, seller, re-seller, or subcontracted service agent, upon purchase of the individual device, such as a typical server warranty. In some cases, the vendor may offer an extended warranty if that option is available. The vendor may support many types of warranties, which can make it difficult for a customer representative to select the correct warranty type applicable for the customer product. For a larger customer accounts, the vendor may allocate a dedicated Technical Account Manager (TAM), who can analyze the customer requirements and help the customers with required warranty types. Unfortunately, customers may experience extended system downtime or degraded functionality when a non-optimal warranty has been purchased for the device. There are multiple reasons that contribute to the selection of a non-optimal warranty, such as limited understanding of cost or available warranty offerings, or changes in device usage or intent after purchase.

Warranties typically have common features, such as warranty type that identifies the covered component types (e.g., software or hardware), a warranty replacement SLA that identifies the level of services expected by the customer from the vendor (e.g., next business day (NBD), second business day (SBD), four hours (4 H), eight hours (8 H), mission critical (MC), etc.), and a support type that identifies the types of support provided (e.g., engineer/technician level one, two, or three (L1, L1+L2, L1+L2+L3), Post Support, etc.) or other support based on standard naming conventions. The warranty will also identify a warranty start date and a warranty end date. The warranty SLA can have a significant impact on the customer's operations. For example, a server with an SBD warranty may experience downtime up to two days, which could have been reduced to four hours if a 4 H response warranty was in place.

In the illustrated embodiment of FIG. 1, data centers 101a-d are located in different cities 103-106, and each city 103-106 has different levels of service available. Another city 108 may provide vendor warranty support but has no data center associated with operations center 102. Service centers 109 and 110, respectively, are available in cities 103 and 104. Accordingly, if on-site technical support is needed, then data centers 107a,b would have the necessary support type available locally. On the other hand, data centers 107c,d would have to rely on support from service centers 109-111 in another city. Service centers 109-110 may also be staffed so that various combinations of support levels (e.g., L1, L1+L2, L1+L2+L3) may be available at different service centers. Similarly, warehouses 112, 113, respectively, are available in cities 103 and 105. Accordingly, if replacement parts are needed, then data centers 107a,c would more likely have the required parts available locally. On the other hand, data centers 107b,d would have to rely on parts shipped from warehouses 112-114 in another city. Cities 103-106 may be ranked as Tier 1, Tier 2, etc. based upon the availability of service centers and warehouses. The operations center 102, or a system management console 102a may be in contact with a vendor warranty system 115 either directly or through a public network 116, such as the Internet. Vendor warranty system 115 may track warranty terms and coverage for deployed IHSs 107a-d. For example, vendor warranty system 115 may comprise a customer support database 10 and a cluster warranty database 20. Customer support database 10 may store warranty information, such as terms and conditions, SLA, and other details for customer warranties. Cluster warranty database 20 tracks cluster membership and cluster warranty grants to nodes in the clusters. Vendor warranty system 115 may further comprise a deep learning neural network (DLNN) 30 that identifies clusters of devices within data centers 101a-d and manages cluster warranties for those devices.

There can be gaps in warranty offers. For example, while some of warranty offers may have three warranty types (e.g., L1, L1+L2, L1+L2+L3), in other warranties only L1 or L1+L2 might be offered. Moreover, in some cases a warranty offers coverage for products such as system management software; however, other warranty offers may not provide such coverage. At times, there may be high volume of requests for support or part replacement that is not usually covered by warranty offers. If the volume of such requests increases, then the vendor may need to offer warranties with appropriate coverage, which would increase warranty revenue and increase customer confidence.

Certain scenarios can create negative customer experiences if the wrong warranty is in place. For example, a server's performance may be degraded for an extended time due to redundant part failures, such as failure of one drive in a Redundant Array of Independent Disks (RAID) virtual disk. A server may experience extended downtime due to the time required to replace a failed critical part, such as a CPU, memory, backplane, or system board failure. A servers may have to function with an extended risk due to redundant part failures, such as a power supply unit (PSU) or fan failure. Customer awareness of warranty coverage may also cause customer dissatisfaction. For example, if a customer is not aware that a certain failure is within warranty support, then the customer will never report the issue and may instead request part replacement, which may result in unnecessary downtime and cost that could have been avoided.

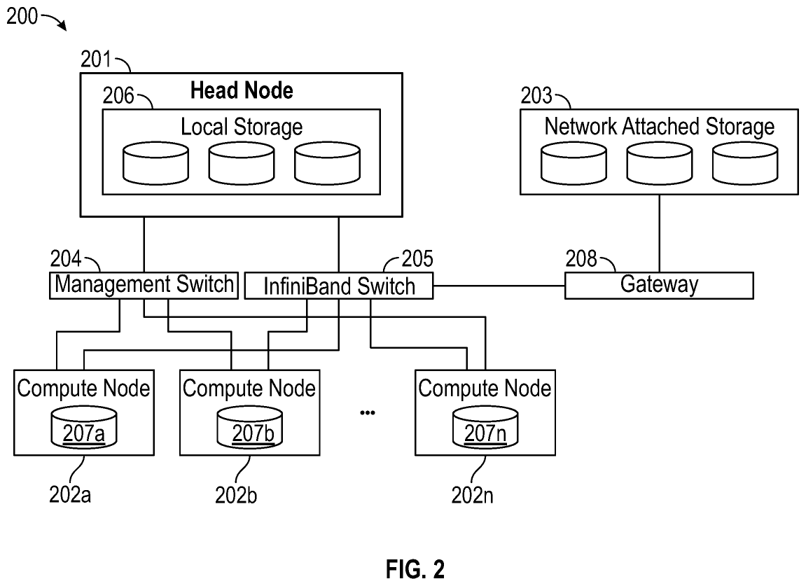

The devices in each data center 101a-d, such as IHSs 107a-d, may be organized into logical groups or clusters. FIG. 2 illustrates the architecture for a logical group or cluster 200 of IHSs or other devices. Cluster 200 comprises a head node 201, child compute nodes 202a-n, shared storage 203, and networks 204, 205. The head node 201, or master node, is used to deploy the cluster of compute nodes 202a-n, manage the compute node images, and provide tools to support job submission to compute nodes 202a-n. The compute nodes 202a-n execute assigned workloads and execute jobs submitted by users.

Head node 201 may have local storage 206, and compute notes 202a-n may have their own local storage 207a-n. The local disks 206 on cluster head node 201 and network attached storage 203 may be accessed by computer nodes 206a-n via a network file system (NFS). Head node 201 and compute nodes 202a-n are interconnected through InfiniBand switch 205, which provides network communications with a very high throughput and very low latency. Network attached storage 203 is also connected to InfiniBand switch 205 thorough a gateway 208 that allows for high-speed application performance while simultaneously consolidating network and I/O infrastructure. All compute nodes 202a-n and head node 201 are also connected to management switch 204 that supports in-band and out-of-band management via a remote access controller as well as cluster provisioning and deployment.

Cluster 200 is a combination of hardware and software. The hardware may comprise, for example, servers, chassis, switches, blades, prebuilt appliances (e.g., preconfigured virtual machines), and disk devices (e.g., Just a Bunch Of Disks (JBODs)). The software may comprise, for example, a virtual storage area network, virtual storage appliance, software-defined storage, server virtualization software, and hypervisor. Each of these individual hardware and software components may have an individual warranty attached. Typically, this individual warranty would be valid for some defined term, such as one, two, or three years, after the component was purchase or put in service. When these individual components are put together in a logical group, such as cluster 201, the warranty expiration dates are not necessarily the same. Instead, the warranty expiration dates usually depend on the purchase date of the individual components, even for identical components in the cluster. In existing data centers, this is likely to result in uneven warranty expiration across nodes, storage devices, and software for the same cluster, which creates unpredictable SLAs since the SLAs for components with expired warranties are no longer valid.

Any component's warranty expiration impacts the entire cluster's workload availability. Additionally, warranty expiration for a node can make it difficult to service software warranty issues since the issue must be reported on a device that still has an active software warranty. So, if the software failure occurs on hardware with an expired warranty, then that could complicate efforts to obtain support for the software. One option to address the problems created by uneven warranty expiration dates is to build clusters with devices purchased at the same time. Alternatively, the customer could sign up for an additional warranty period for older devices so that the warranty is good for the duration of the cluster deployment. However, this is unrealistic since purchase decisions are driven by budgetary considerations, and it is usually difficult (and not a typical procedure) for data center administrators to create clusters or logical groups using this kind of criteria.

The solution proposed herein is a logical-physical warranty concept that can be applied to a logical grouping, such as a cluster, software defined environment, edge data center, etc. Using this concept creates an additional “logical” warranty that is associated with the logical group or cluster. This logical warranty stretches the warranty expiration dates for individual warranties to a worst-case date inside a logical group. There may be a need for vendor approval to ensure that the extended dates in the logical warranty comply with the vendor's warranty guidelines. However, in order to avoid misuse of the logical warranty, the logical warranty is also attached to service tags for all participating nodes in the cluster. The service tags may be, for example, any unique identifier, product identifier, serial number, service code, or agreement identifier that can be tied to a warranty or service agreement.

The logical warranties will allow customers to build, teardown, and extend clusters. When customers are not sure of the potential size of the cluster over its lifetime (e.g., expansion to a 4-node, 8-node, or 16-node cluster), the customer may purchase the relevant warranty for a current size to avoid undue cost while retaining the ability to expand the cluster later as needed. This solution ensures that there will be a uniform SLA for the entire cluster during the warranty lifetime of the cluster, which also simplifies the ability to obtain and provide support.

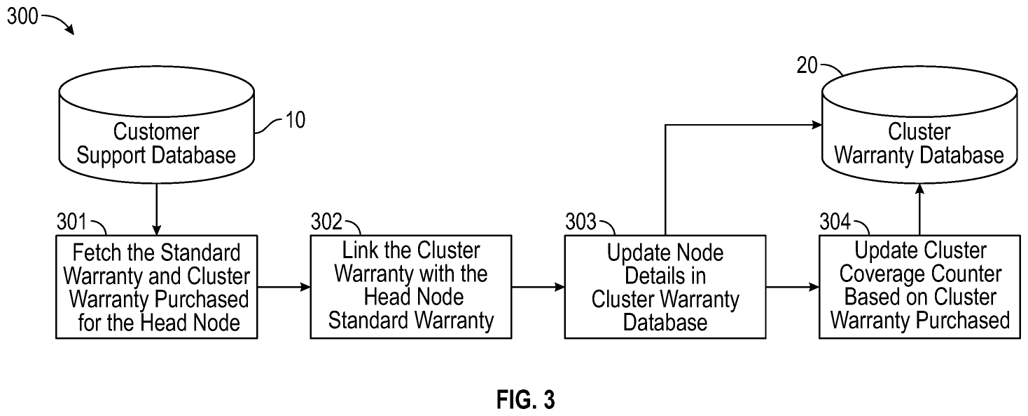

FIG. 3 is a flowchart 300 illustrating a process for adding a head node to a cluster warranty. As used herein, the term cluster refers to any logical grouping of devices, such as servers, IHSs, storage devices, etc. A vendor maintains a customer support database 10 and a cluster warranty database 20. Customer support database 10 may store warranty information, such as terms and conditions, SLA, and other details for customer warranties. Cluster warranty database 20 tracks cluster membership and cluster warranty grants to nodes in the clusters. When a customer purchases a node, they are offered an additional “cluster level warranty,” which may be purchased only for the head node or first node in the cluster. Customer may purchase a cluster level warranty for the appropriate size cluster (e.g., 4-node, 8-node, 16-node, etc.). This cluster warranty size limitation restricts the number nodes to which the cluster warranty can be applied.

The data center or IT administrator should ensure that when they are creating the cluster, all of the nodes in the cluster should have same set of standard warranties (i.e., the warranties covering the individual devices). Only one node—the head node—can have the cluster level warranty. The expiration dates for the standard warranties for nodes in the cluster do not need to be the same. However, the nodes in the cluster cannot include devices of different models or product generations. Depending upon the industry and product, vendors typically release a new generation of a product every one to four years where the new generation has features that distinguish over prior the generation, such as similar functions that have new solutions or the addition of new features and functions. Typically, the vendor will annotate a product name to indicate the generation (e.g., “2.0,” “3.0,” “2G,” “3G”). By limiting the cluster warranty to devices of the same generation, the nodes covered under the cluster warranty will have similar service histories and common parts, which allows the vendor to apply the same SLAs across each node. The cluster warranties may be limited to devices of the same model or an allowed combination of models.

At least two nodes are required for creating a cluster. The head node is the node for which a cluster warranty was purchased. In step 301, the standard node warranty and cluster warranty for the head node are retrieved from customer support database 10. The head node is the first node added to a cluster. Customers have to opt for cluster warranty while purchasing the head node. The warranties may be fetched using a service tag or any other unique identifier, product identifier, serial number, service code, or agreement identifier for the node. The head node may have multiple individual warranties covering different feature and components, such as separate hardware and software warranties and/or warranties for specific components. In step 302, the standard warranty and the cluster warranty are linked for the head node. The cluster warranty is baselined with the head node warranty and cluster node count is set based on customer preference. For example, if the customer has opted for a 4-node cluster warranty, then cluster warranty counter is set to four.

In step 303, the head node details are updated to the cluster warranty database 20. For example, cluster warranty expiration dates may be set to the standard warranty expiration dates for individual warranties of the head node.

In step 304 a cluster coverage counter is updated. The cluster warranty is tracked against the service tag of head node, so this service tag must be passed with all requests related to the cluster warranty.

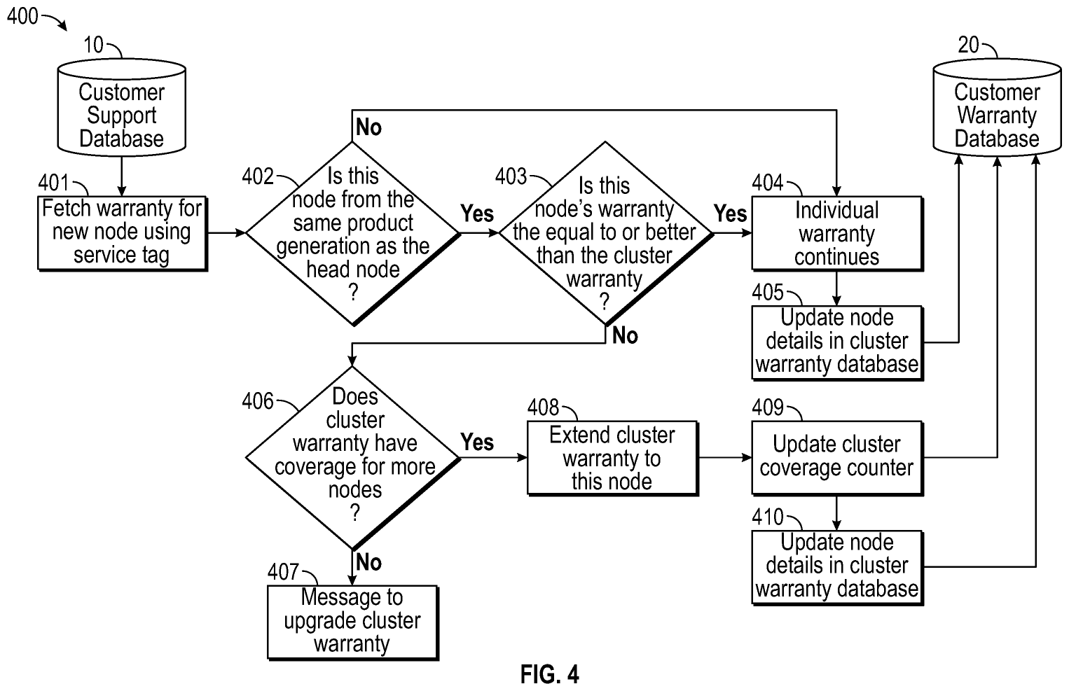

FIG. 4 is a flowchart 400 illustrating a process for adding a new node to a cluster warranty. Once the head node is designated, the customer may add additional nodes to the cluster in a data center using the appropriate addressing and other logical connections. The individual warranty for the new node is also linked to the cluster warranty associated with the head node. In step 401, the service tag for a new node is retrieved using the service tag for the new node. In step 402, a determination is made whether the node being added is from the same product generation as the head node. Devices from different product generations have different features and components, which can make it difficult to group devices that require different service or parts. Alternatively, in step 402 instead of looking for the same product generation, a group of related or similar product generations are predefined, such as when changes between generations have little effect on warranty service or SLA.

If the new node and the head node are from the same product generation in step 402, then a determination is made at step 403 whether the terms for the new node's warranty are equal to or better than the cluster warranty. The terms for consideration may be, for example, warranty end dates, part-replacement, SLA, etc. In one embodiment, the expiration dates for warranties of the added node are compared with corresponding expiration dates of the cluster warranty to check if the dates are equal, higher, or lower than the cluster warranty.

In a first example case, the cluster warranty is:
{type: “prosupport”, critical: “MissionCritical”, product: “SAN”, support type: “Advanced Software Support”, Exp-Date: “1 Jan. 2022”}, and
the newly added node warranty is:
{type: “prosupport”, critical: “MissionCritical”, product: “SAN”, support type: “Advanced Software Support”, Exp-Date: “1 Jan. 2023”}

This new node has an equal or better warranty expiration date than the cluster, so it has no impact to the cluster warranty and is approved to be added to the cluster and added to the cluster warranty database 20. The new node is then additionally associated with the cluster warranty as an added entry in the warranty list of items. The effective expiration year of the warranty for the node and cluster is 2022; however, after 1 Jan. 2022, the individual node warranty will kick-in for the remainder of the term until 1 Jan. 2023.

In a second example case, the cluster warranty is:
{type: “prosupport”, critical: “MissionCritical”, product: “SAN”, support type: “Advanced Software Support”, Exp-Date: “1 Jan. 2023”}, and
the newly added node warranty is:
{type: “prosupport”, critical: “MissionCritical”, product: “SAN”, support type: “Advanced Software Support”, Exp-Date: “1 Jan. 2022”}

This new node has a worse warranty expiration date than the cluster. The new node is approved to be added to the cluster and added to the cluster warranty database 20. The new node is then additionally associated with the cluster warranty as an added entry in the warranty list of items. The expiration year of the warranty for both the node and cluster is 2023, so the warranty for the new node has effectively been extended to match the cluster.

If the individual warranty for the new node has better terms than the cluster warranty, then in step 403 the new node's individual warranty continues as the primary warranty for that node and the process moves to step 404. Similarly, if the new node and the head node are from different product generations in step 402, the process also moves to step 404, and the new node's individual warranty continues.

In step 405, the node details are updated in the cluster warranty database 20 and the new node is linked to the cluster warranty. However, since the warranty for the individual node is better than the cluster warranty, the cluster count is not updated since the individual warranty is continuing. In this case, cluster warranty database 20 maintains two warranties: the individual warranty for the new node, and the cluster warranty.

If, at step 403, the individual warranty for the new node does not have better terms than the cluster warranty, then in step 406 a determination is made whether the cluster coverage still has coverage available for additional nodes. In some embodiments, a cluster node counter is set at the appropriate node number for the cluster (e.g., 4, 8, 16, etc.) and is decremented each time a new node is added. In such a case, a determination is made whether the cluster node counter is greater than zero in step 406. If no additional node coverage is available in step 406, then in step 407 a message is sent to the customer to update the cluster warranty, if possible, to add additional node coverage.

If, at step 406, there is additional coverage available for more nodes, then in step 408 the cluster warranty is extended to the new node. In step 409, the cluster coverage counter is updated in cluster warranty database 20 so that additional nodes can be added only if within the scope of the cluster level warranty. In step 410, the new node details are updated in the cluster warranty database 20.

The cluster warranty applies to nodes in case any individual node warranty expires. No more than the allowed number of nodes for the cluster level warranty can be associated to the head node service tag. Accordingly, this provides a method to cover a node under warranty as long as it is part of the covered cluster. The physical nodes within the cluster can be extended and then the cluster level warranty extended to those new physical nodes as long as the cluster node count at the time of cluster warranty purchase is not exceeded.

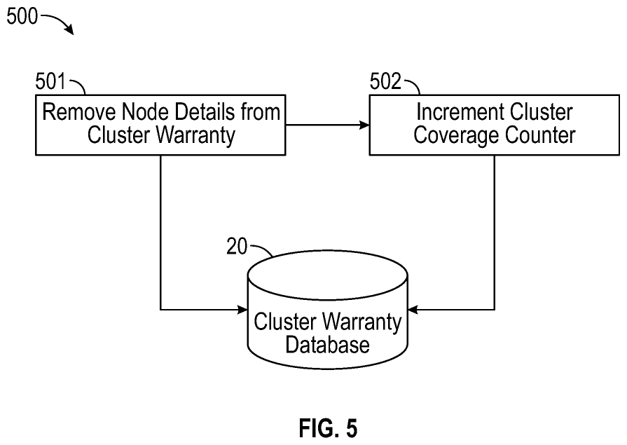

FIG. 5 is a flowchart 500 illustrating a process for removing a node from a cluster. In step 501, when a customer decides to remove a physical node from an existing cluster, the node details are also removed from the cluster warranty. Referring to the head node's service tag, the removed node's details are updated in cluster warranty database 20. In step 502, the cluster coverage counter is incremented to indicate that there is space for at least one new node in the cluster warranty. The cluster coverage counter is updated in cluster warranty database 20. The removed node will no longer be covered under the cluster level warranty; however, the removed node will continue with its own individual warranty, if any.

In one embodiment, DLNN 30 (FIG. 1) may manage the cluster level warranties by identifying clusters of nodes, analyzing the warranties for the head node and child compute nodes, and identifying components, features, and product generations for the nodes. DLNN 30 may automatically add new nodes to a cluster warranty or remove old nodes form the cluster warranty. DLNN 30 may identify to customers and vendors situations where new cluster nodes should be added, or existing cluster nodes should be upgraded to provide coverage for additional nodes. For example, DLNN 30 may perform the processes 300, 400, 500 illustrated in FIGS. 3-5.

The DLNN may be an artificial intelligence (AI) or machine learning (ML) engine or processor that executes software instructions that operate to combine large amounts of data with fast, iterative processing and intelligent algorithms, which thereby allow the software to automatically learn from patterns and features in the data. The DLNN may use machine learning, which automates analytical model building using methods from neural networks and statistics to find insights into data without explicitly programming regarding what to look for and what to conclude. A neural network is made up of interconnected units that processes information by responding to external inputs and relaying information between each unit. The process may require multiple iterations processing the data to find connections and derive meaning from unstructured data. The DLNN may use advanced algorithms to analyze large amounts of data faster and at multiple levels. This allows intelligent processing for identifying and predicting rare events, understanding complex systems, and identifying unique scenarios. The DLNN may use application programming interfaces (APIs) to add functionality to existing systems and software. The DLNN can reason on input data and output an explanation of the data.

DLNN algorithms for cluster level warranties are trained using an appropriate set of parameters. For example, the DLNN may trained using parameter related to the devices available in a data center (e.g., as identified by service tags), components or features of the devices, logical groups and node clusters in the data center, workload types assigned to clusters, and warranty SLAs and other terms and conditions. The algorithm generates recommendations for assigning cluster warranties to logical groups, for adding and removing nodes from cluster warranties, and for upgrading/downgrading cluster warranties when cluster sizes change. The warranty data is categorized by assigning weights and bias to each parameter and identifying opportunities to apply a cluster warranty to logical groups. The details are stored in customer support database 10 and cluster warranty database 20.

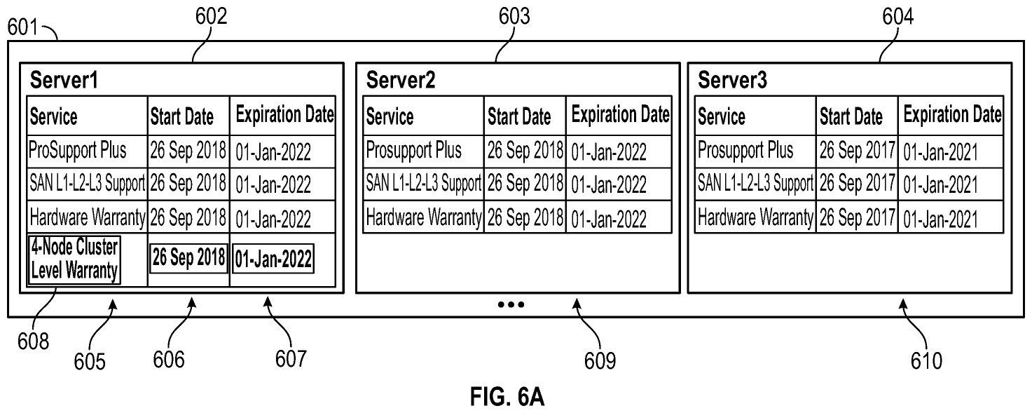

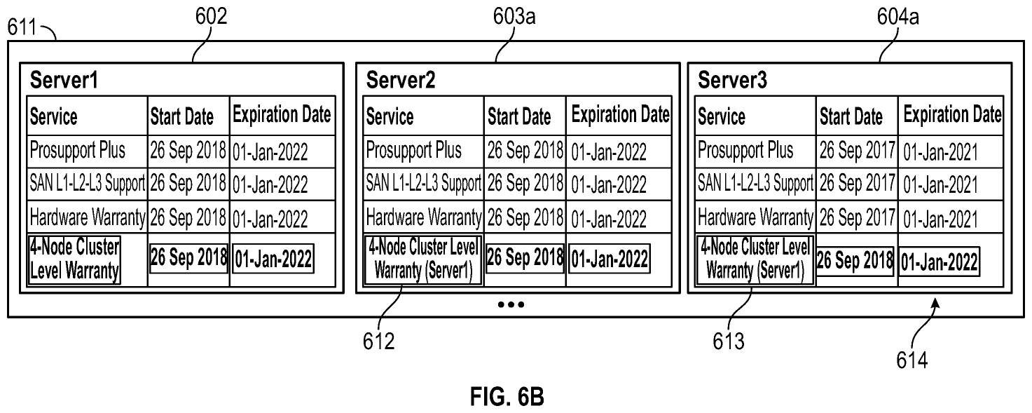

FIG. 6A illustrates a set of warranties 601 associated with three independent nodes (SERVER1, SERVER 2, SERVER3) that are to be combined in a cluster. Each node has its own individual warranty 602-604, which may be stored in customer support database 10, for example. As illustrated, each warranty 602-604 identifies a number of different services 605 that are covered by the warranty along with the start date 606 and end date 607 for that coverage. SERVER1 is designated as the head node for the cluster and, therefore, warranty 602 for SERVER1 includes a cluster level warranty shown in line 608. Cluster level warranty 608 is specifically for a 4-node cluster. The expiration date for warranty 602, including the cluster level warranty, is 1 Jan. 2022.

Warranties 603 and 604 are associated with SERVER2 and SERVER3, respectively, which are intended to be child compute nodes in the cluster with head node SERVER1. SERVER2 warranty 603 expires 1 Jan. 2022 (609), and SERVER3 warranty 604 expires 1 Jan. 2021 (610). Since SERVER2 and SERVER3 are not intended as head nodes, warranties 603 and 604 do not include a cluster warranty at time of purchase. SERVER2 and SERVER3 are of the same model or product generation as SERVER1, which allows them to be linked under the same cluster warranty.

FIG. 6B illustrates a set of warranties 611 for the nodes (SERVER1, SERVER 2, SERVER3) that have been linked under a cluster warranty. The warranty for SERVER2 has been updated 603a to include the cluster level warranty for SERVER1 as shown in line 612. Similarly, the warranty for SERVER3 has been updated 604a to include the cluster level warranty for SERVER1 as shown in line 613. Originally, warranty 604 SERVER3 had an expiration date of 1 Jan. 2021 (610), which was earlier than the expiration date for SERVER1 warranty 602. However, once cluster warranty 608 is linked to warranty 604a, the expiration date for SERVER3's warranty is extended to expires 1 Jan. 2022 (614) to match the expiration of warranties 602 and 603a for nodes SERVER1 and SERVER2. If node SERVER3 is later removed from the cluster or logical group, then the cluster warranty 613 will also be removed from warranty 604a. Once removed from the cluster, SERVER3's warranty would revert back to the original expiration date of 1 Jan. 2021 (610).

In an example embodiment, an information handling system for grouping warranties for nodes within a data center comprising a processor and a memory coupled to the processor. The memory having program instructions stored thereon that, upon execution by the processor, cause the system to identify a head node within the data center, the head node having an assigned service tag; retrieve a warranty record for the head node using the head node service tag, wherein the warranty record comprises data identifying one or more head node warranty services; verify that the head node warranty record includes a logical group warranty having a first designated expiration date; identify a child node within the data center, the child node having a unique service tag; retrieve a warranty record for the child node using the unique service tag, wherein the child node warranty record comprises data identifying one or more child node warranty services having a second designated expiration date; and modify the child node warranty record to include the logical group warranty.

The head node warranty record may comprise an SLA, and the child node warranty record may comprise an identical SLA after modification to include the logical group warranty.

The head node and the child node may be separate physical devices that are grouped in a single logical group by a user. The logical group may be a cluster of server devices.

The program instructions may further cause the system to modify the second designated expiration date to equal the first designated expiration date.

The program instructions may further cause the system to update a cluster warranty database to include the child node warranty record as modified to include the logical group warranty and to include the one or more child node warranty services having the first designated expiration date.

The program instructions may further cause the system to determine whether the head node and the child node are a same product generation or model.

The program instructions may further cause the system to determine whether a head node model identifier and a child node model identifier are both within a same predefined model group.

The program instructions may further cause the system to compare the first designated expiration date and the second designated expiration date; and if the first designated expiration date is after the second designated expiration date, then modify the child node warranty record to include the logical group warranty.

The program instructions may further cause the system to compare the first designated expiration date and the second designated expiration date; and if the second designated expiration date is after the first designated expiration date, then maintain the second designated expiration date for the one or more child node warranty services.

The program instructions may further cause the system to determine if a node counter associated with the logical group warranty indicates that additional nodes can be added to the logical group warranty before modifying the child node warranty record.

The program instructions may further cause the system to notify a user to update the logical group warranty, if a node counter associated with the logical group warranty indicates that no additional nodes can be added to the logical group warranty.

In a further example embodiment, a computer program product comprises a computer readable storage medium having program instructions embodied therewith, the program instructions are executable by a processor to cause the processor to perform a method comprising identifying a head node and at least one child node within the data center, the head node having an assigned head node service tag, and the child node having an assigned child node service tag; retrieving a head node warranty record using the head node service tag, wherein the head node warranty record comprises data identifying one or more head node warranty services; retrieving a child node warranty record using the child node service tag, wherein the child node warranty record comprises data identifying one or more child node warranty services; verifying that the head node warranty record includes a logical group warranty having a first expiration date; confirming that the child node warranty services have a second expiration date that is later than the first expiration date; and modifying the child node warranty record to include the logical group warranty and to assign the first expiration date to the child node warranty services.

The program instructions may further cause the processor to update a cluster warranty database to include the child node warranty record as modified to include the logical group warranty and to include the one or more child node warranty services having the first designated expiration date.

The program instructions may further cause the processor to determine whether the head node and the child node are a same product generation or model.

The program instructions may further cause the processor to determine if a node counter associated with the logical group warranty indicates that additional nodes can be added to the logical group warranty before modifying the child node warranty record.

The program instructions may further cause the processor to notify a user to update the logical group warranty, if a node counter associated with the logical group warranty indicates that no additional nodes can be added to the logical group warranty.

The head node warranty record may comprise an SLA, and the child node warranty record may comprise an identical SLA after modification to include the logical group warranty. The head node and the child node may be separate physical devices that are grouped in a single logical group by a user. The logical group may be a cluster of server devices.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. An information handling system for grouping warranties for nodes within a data center, the information handling system comprising:
a processor; and
a memory coupled to the processor, the memory having program instructions stored thereon that, upon execution by the processor, cause the system to:
identify a head node within the data center, the head node having an assigned service tag;
retrieve a warranty record for the head node using the head node service tag, wherein the warranty record comprises data identifying one or more head node warranty services;
verify that the head node warranty record includes a logical group warranty having a first designated expiration date;
identify a child node within the data center, the child node having a unique service tag;
retrieve a warranty record for the child node using the unique service tag, wherein the child node warranty record comprises data identifying one or more child node warranty services having a second designated expiration date; and
modify the child node warranty record to include the logical group warranty.

2. The information handling system of claim 1, wherein the program instructions, upon execution by the processor, further cause the system to:
modify the second designated expiration date to equal the first designated expiration date.

3. The information handling system of claim 1, wherein the program instructions, upon execution by the processor, further cause the system to:
update a cluster warranty database to include the child node warranty record as modified to include the logical group warranty and to include the one or more child node warranty services having the first designated expiration date.

4. The information handling system of claim 1, wherein the program instructions, upon execution by the processor, further cause the system to:
determine whether the head node and the child node are a same product generation or model.

5. The information handling system of claim 1, wherein the program instructions, upon execution by the processor, further cause the system to:
determine whether a head node model identifier and a child node model identifier are both within a same predefined model group.

6. The information handling system of claim 1, wherein the program instructions, upon execution by the processor, further cause the system to:
compare the first designated expiration date and the second designated expiration date; and
if the first designated expiration date is after the second designated expiration date, then modify the child node warranty record to include the logical group warranty.

7. The information handling system of claim 1, wherein the program instructions, upon execution by the processor, further cause the system to:
compare the first designated expiration date and the second designated expiration date; and
if the second designated expiration date is after the first designated expiration date, then maintain the second designated expiration date for the one or more child node warranty services.

8. The information handling system of claim 1, wherein the program instructions, upon execution by the processor, further cause the system to:
determine if a node counter associated with the logical group warranty indicates that additional nodes can be added to the logical group warranty before modifying the child node warranty record.

9. The information handling system of claim 1, wherein the program instructions, upon execution by the processor, further cause the system to:
notify a user to update the logical group warranty, if a node counter associated with the logical group warranty indicates that no additional nodes can be added to the logical group warranty.

10. The information handling system of claim 1, wherein the head node warranty record comprises a Service Level Agreement (SLA), and wherein the child node warranty record comprises an identical SLA after modification to include the logical group warranty.

11. The information handling system of claim 1, wherein the head node and the child node are separate physical devices that are grouped in a single logical group by a user.

12. The information handling system of claim 11, wherein the logical group is a cluster of server devices.

13. A computer program product comprising a computer readable storage medium having program instructions embodied therewith, the program instructions executable by a processor to cause the processor to perform a method comprising:
identifying a head node and at least one child node within the data center, the head node having an assigned head node service tag, and the child node having an assigned child node service tag;
retrieving a head node warranty record using the head node service tag, wherein the head node warranty record comprises data identifying one or more head node warranty services;
retrieving a child node warranty record using the child node service tag, wherein the child node warranty record comprises data identifying one or more child node warranty services;
verifying that the head node warranty record includes a logical group warranty having a first expiration date;
confirming that the child node warranty services have a second expiration date that is later than the first expiration date; and
modifying the child node warranty record to include the logical group warranty and to assign the first expiration date to the child node warranty services.

14. The computer program product of claim 13, wherein the program instructions further cause the processor to:
update a cluster warranty database to include the child node warranty record as modified to include the logical group warranty and to include the one or more child node warranty services having the first designated expiration date.

15. The computer program product of claim 13, wherein the program instructions further cause the processor to:
determine whether the head node and the child node are a same product generation or model.

16. The computer program product of claim 13, wherein the program instructions further cause the processor to:
determine if a node counter associated with the logical group warranty indicates that additional nodes can be added to the logical group warranty before modifying the child node warranty record.

17. The computer program product of claim 13, wherein the program instructions further cause the processor to:
notify a user to update the logical group warranty, if a node counter associated with the logical group warranty indicates that no additional nodes can be added to the logical group warranty.

17. The computer program product of claim 13, wherein the head node warranty record comprises a Service Level Agreement (SLA), and wherein the child node warranty record comprises an identical SLA after modification to include the logical group warranty.

18. The computer program product of claim 13, wherein the head node and the child node are separate physical devices that are grouped in a single logical group by a user.

19. The computer program product of claim 18, wherein the logical group is a cluster of server devices.
